(19) United States
(12) Patent Application Publication
(10) Pub. No.: US 2021/0307266 A1
(43) Pub. Date: Oct. 7, 2021

(54) DRAINAGE DEVICE AND SYSTEM FOR PLANT POTS

(71) Applicant: Shimon Adi PHIMA, Haifa (IL)

(72) Inventor: Shimon Adi PHIMA, Haifa (IL)

(21) Appl. No.: 17/267,147

(22) PCT Filed: Aug. 8, 2019
(86) PCT No.: PCT/IB2019/056757

§ 371 Date: Feb. 9, 2021

Related U.S. Application Data
(60) Provisional application No. 62/716,378, filed on Aug. 9, 2018.

(51) Int. Cl. A01G 27/00; A01G 9/04

(52) U.S. Cl. CPC A01G 27/005; A01G 9/042; A01G 27/008

(57) ABSTRACT

A drainage device, system and arrangement for a plant pot, including: (a) a tray adapted to receive drainage fluid from the plant pot; (b) a cover for the drainage tray, the cover being permeable and adapted for a base of the plant pot to stand thereon, further adapted for the drainage fluid from the plant pot to pass there-through, into the tray; (c) an outlet port disposed in a sidewall of the tray; and (d) a drainage tube connected to the outlet port, the drainage tube adapted to provide a conduit for conveying the drainage fluid out of the tray.

### FIELD OF THE INVENTION

The present invention relates to a device and system for managing drainage fluid that seeps out of plant pots. The present invention provides a solution for preventing mess and damage from water leaking out of plant and flower pots. Embodiments of the present solution also recycle the water for re-irrigation.

### BACKGROUND OF THE INVENTION

Growing plants in the house and/or on the porch can be a source of mess and damage as well as being a potential slipping hazard, when water leaks out of the plant and flower pots. It is a common occurrence for water drainage from the flowerpots to flow over the edges of the drainage saucers on the bottom of planters and plant pots.

Stagnant water in the saucers under plant and flower pots is an ideal breeding ground for mosquitoes and other pests. In addition, water conservation is an important issue and water used for plants is considered very wasteful.

### SUMMARY OF THE INVENTION

According to the present invention there is provided a drainage device for a plant pot, including: (a) a tray adapted to receive drainage fluid from the plant pot; (b) a cover for the drainage tray, the cover being permeable and adapted for a base of the plant pot to stand thereon, further adapted for the drainage fluid from the plant pot to pass there-through, into the tray; (c) an outlet port disposed in a sidewall of the tray; and (d) a drainage tube connected to the outlet port, the drainage tube adapted to provide a conduit for conveying the drainage fluid out of the tray.

According to further features in preferred embodiments of the invention described below the drainage tube is coupled to a reservoir that is adapted to receive the drainage fluid and filter the drainage fluid to receive filtered fluid.

According to still further features in the described preferred embodiments the filtered fluid is recycled back into the plant pot.

According to further features the device further includes a pump adapted to convey under pressure the filtered fluid from the reservoir to the plant pot, through an irrigation tube.

According to further features the pump is located inside or outside the reservoir. According to further features the drainage tube is in fluid communication with a reservoir. According to further features the reservoir is in fluid communication with a secondary reservoir that is adapted to receive the drainage fluid and filter the drainage fluid to receive filtered fluid; and further including a pump operationally coupled to the secondary reservoir, the pump adapted to move the filtered fluid to the plant pot through an irrigation tube that is in fluid communication with the pump and the plant pot. According to further features the pump is located inside or outside the reservoir.

According to further features the drainage tube terminates at a disposal point.

According to further features the drainage tube is operationally coupled to an inlet port of an additional drainage device of claim 1.

According to further features the device further includes a one-way valve disposed in the inlet port and/or outlet port. According to further features the device further includes a mechanical device configured to generate pressure to move the drainage fluid out of the tray. According to further features the mechanical device is a pump, the pump is disposed inside or outside the drainage device and coupled to the outlet port.

According to another embodiment there is provided a drainage system, including: (a) a plurality of drainage devices arranged in a sequence, including at least a first device and a last device, each device comprising: (i) a tray adapted to receive drainage fluid from the plant pot, (ii) a cover for the drainage tray, the cover being permeable and adapted for a base of the plant pot to stand thereon or there-over, further adapted for the drainage fluid from the plant pot to pass there-through to the tray, (iii) an outlet port disposed in a sidewall of the tray, and (iv) an inlet port disposed in the sidewall of the tray, opposite the outlet port; (b) a plurality of tubes coupling each drainage device of the plurality of devices with a subsequent the drainage device in the sequence, the tubes adapted to serve as conduits for drainage fluid to flow from each the drainage device to the subsequent drainage device, until the last device; and (c) a drainage tube connected to the outlet port of the last device, the drainage tube adapted to provide a conduit for conveying the drainage fluid out of the last device in the sequence.

According to further features the drainage tube terminates at a disposal point.

According to further features the system further includes (d) a reservoir, the reservoir operationally coupled to the last device via the drainage tube and adapted to receive the drainage fluid there-from. According to further features the reservoir is adapted to filter the drainage fluid to receive filtered fluid for reuse.

According to further features the system further includes: (e) a mechanical device configured to generate pressure to move the filtered fluid to a plurality of plant pots. According to further features each of the plurality of plant pots is located on top of a respective the drainage device of the plurality of drainage devices.

According to further features at least two plant pots of the plurality of plant pots are located on top of at least one the drainage device of the plurality of drainage devices. According to further features the mechanical device is disposed inside or outside the reservoir.

According to further features the system further includes: (e) a secondary reservoir adapted to receive drainage fluid or filtered fluid from the reservoir, the secondary reservoir in fluid communication with a pump adapted for propelling the filtered fluid to a plurality of plant pots.

According to further features each drainage device further includes: (v) a one-way valve disposed in said inlet port and/or the outlet port.

According to further features each drainage device further includes: (v) a mini submersible liquid water pump operationally coupled to said outlet port and configured to pump said drainage fluid out of said drainage device.

### BRIEF DESCRIPTION OF THE DRAWINGS

Various embodiments are herein described, by way of example only, with reference to the accompanying drawings, wherein:

FIG. 1A to 1J are various embodiments, variations and perspective views of a drainage device 10 according to the immediate invention;

FIG. 2A to 2E are a various embodiments of the drainage device arranged with a plant pot for drainage only or drainage and irrigation;

FIG. 3A to 3E are various embodiments of a drainage system employing the aforementioned drainage devices;

FIG. 4 is a single drainage device 10 according to the instant innovation, with a number of plant pots 20 are disposed on the device.

### DESCRIPTION OF THE PREFERRED EMBODIMENTS

The principles and operation of a drainage device, method and system according to the present invention may be better understood with reference to the drawings and the accompanying description.

### Drainage Device and Drainage-Irrigation Arrangement

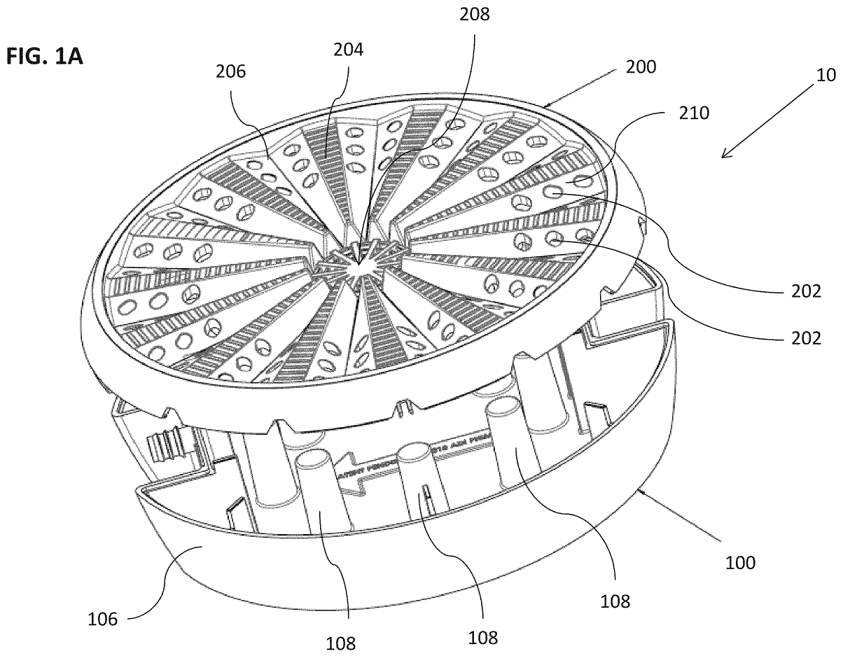

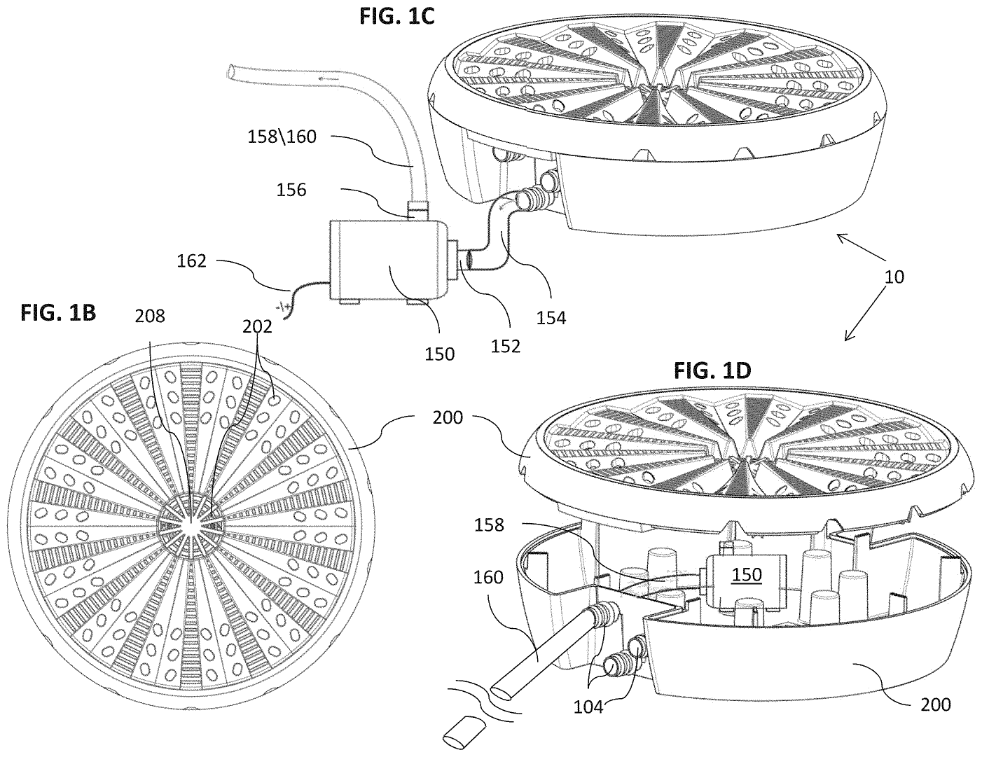

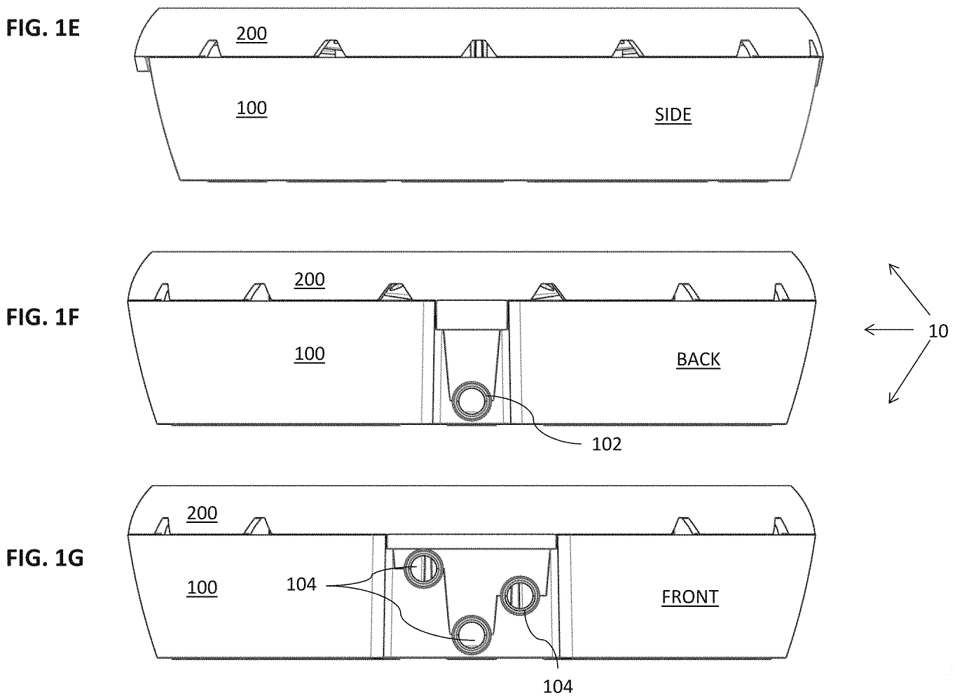

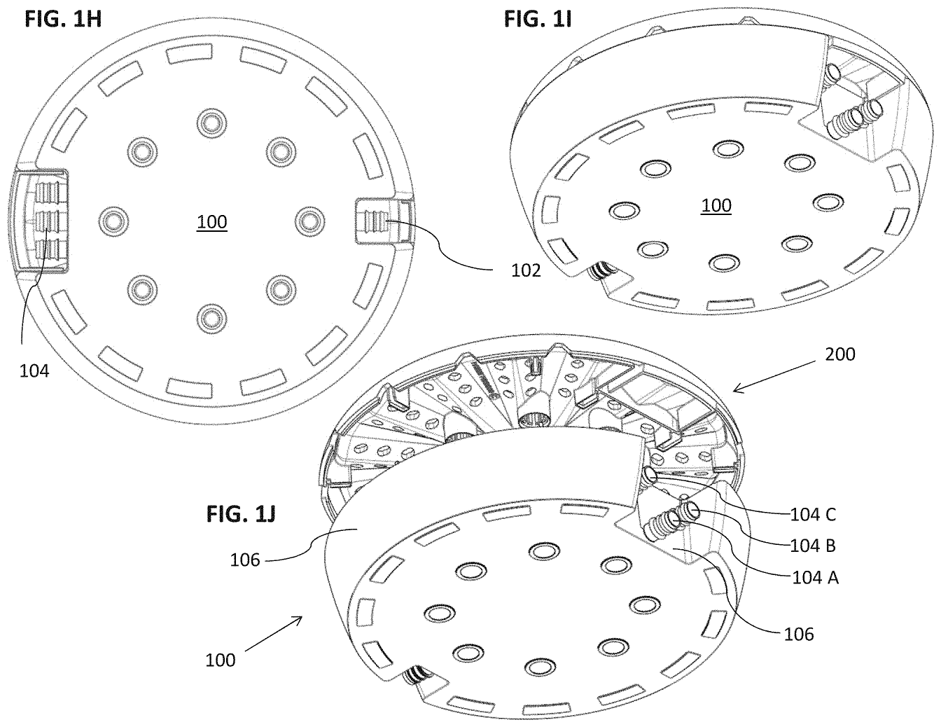

FIGS. 1A to 1J illustrate various embodiments, variations and perspective views of a drainage device 10 according to the immediate invention. In each of the variations/embodiments detailed below, there is a basic unit of the drainage device. In some embodiments, one or more additional components are added to, or incorporated in, the drainage device to make up the individual arrangement, embodiment or variation. It is made clear that the embodiments disclosed hereafter are merely exemplary and any variations and modifications of the systems are intended to be included within the scope of the innovative device.

The basic drainage device 10 includes a tray 100 and a permeable cover 200 that fits on top of the tray, closing in drainage fluid that enters through the cover. The tray and cover closed/locked together prevent spills and minimize access of flying and crawling pests to the fluid inside the device. The basic device 10 further includes an outlet port 104 through which the drainage fluid drains. Constant movement of the drainage fluid prevents stagnation of the fluid. Vacating the device of drainage fluid also prevents spills and insect infestation. For the basic device to be effective, the fluid must be vacated away from the device, without making a mess. A drainage tube 160 is connected to the outside opening of the outlet port 104. Various fluid removable options are detailed below.

FIG. 1A illustrates an isometric view of an exemplary embodiment of the drainage device 10 in a partially opened state. FIG. 1B is a top-down view of the device 10. FIGS. 1C and 1D illustrate additional exemplary embodiments of the invention whereby the drainage device 10 further includes a pump 150. FIG. 1C is a front isometric view of the device 10 in the closed state. FIG. 1C illustrates one exemplary embodiment of the invention whereby a pump 150 is externally connected to the device; such an embodiment is referred to herein as an external pump embodiment. FIG. 1D is a front isometric view of the device 10 in an exploded/separated/partially open view. In the exemplary embodiment, pump 150 is disposed within the drainage device 10; such an embodiment is referred to herein as an internal pump embodiment.

FIG. 1E is a side view of the device 10. FIG. 1F is a back view of the device 10. FIG. 1G is a front view of the device 10.

FIGS. 1H to 1J illustrate another exemplary embodiment of the invention whereby the drainage device 10 is devoid of a pump or any other artificial pressure mechanism. The embodiment of FIGS. 1H to 1J is referred to herein as a gravity embodiment, as gravity powers the flow of the drainage fluid. FIG. 1H is a bottom view of the device 10. FIG. 1I is a bottom isometric view of the device 10 is a closed state. FIG. 1J is a bottom isometric view of the device 10 in an open state where the cover 200 is raised off the tray 100.

Referring to all of the aforementioned embodiments equally, unless specifically stated otherwise, the drainage device 10 includes a tray 100 that is adapted to receive drainage fluid from the plant pot and a permeable cover 200 for the tray. The tray includes an outlet port 104 disposed in a sidewall 106 of the tray. In some embodiments, the device further includes an inlet port 102 disposed in the sidewall, but opposite the outlet port. Preferably the device is circular with a plurality of mini support pillars 108 inside the tray, which are adapted to support additional weight on top of the cover. The cover 200 and tray 100 define a space there-between in which drainage fluid gathers.

The device is configured for a plant pot 20 to be placed on top of, or above (but not resting directly thereon), the cover 200. The term ‘plant pot’ is intended to refer widely to any type of vegetation that is disposed in any type of container or holder that allows irrigation fluid to run out the bottom thereof. For example, the term is intended to include flowerpots, planters (with drainage holes and no saucer), sapling holders, plant trays (with drainage holes). In embodiments, more than one plant pot can be disposed on top of a single drainage device. For example, three small plant pots can be placed on a single drainage device (e.g. see FIG. 4).

In another example, the drainage device can be rectangular in shape and configured to have a tray of plants disposed thereon. The plants may rest directly on the permeable cover or may be suspended over the cover in any kind of arrangement. As such, it is made clear that the circular form depicted in the figures is merely exemplary and not intended to be limiting.

The plant pot has drainage holes in the base of the pot through which drainage fluid drains. Drainage fluid is irrigation fluid (e.g. water or water mixed with nutrients etc.) that has filtered through the vegetation in the plant pot and drains out of the pot.

The cover 200 has one or more holes 202 disposed therein, making the cover a permeable cover. The terms “cover” and “permeable cover” are intended to include any type of cover that minimizes spillage, on the one hand, and on the other hand allows fluid to pass from on top of/over the cover into the tray below the cover. The permeable cover 200 is adapted for a base of one or more plant pots to stand thereon, and further adapted for drainage fluid from the plant pot(s) to pass there-through (i.e. through the cover) into the tray. In some embodiments, such as the exemplary embodiments depicted in the figures (best seen in FIGS. 1A-1D), the cover has a plurality of peaks 204 and valleys 206 arranged in a manner such that the drainage fluid from the plant pot flows to the center of the cover where a strainer 208 is located over a large opening 202. In addition, the slopes 210 of the peaks also have drainage holes 202 disposed therein.

Drainage fluid runs from the plant pots into the inner volume of the drainage device. A unidirectional valve prevents the fluid from running out the inlet port 102. However, in some embodiments, there is no inlet port. When the drainage fluid reaches a predefined level, the fluid flows out of the device via the outlet port 104. In some embodiments there is only a single outlet port 104A. In other embodiments there are two outlet ports (e.g. 104A, 104B), one higher up than the other in the tray sidewall 106. In other embodiments, such as the embodiment depicted in the figures, there are three outlet ports 104A, 104B, 104C, each one positioned at a different height level on the sidewall (best seen in FIGS. 1G-1J).

In embodiments, the outlet port 104 also has a one-way valve, so that the fluid runs out of the tray but does not run back into the tray. If the device has an inlet port, the inlet port can also have a one-way valve to prevent fluid from exiting the tray via the inlet port as mentioned. The one-way valve or valves ensure(s) a unidirectional flow of the drainage fluid from the device to the receptacle or disposal point. The device can utilize gravity (gravity embodiment) to drain the fluid or a mechanical device using suction (negative pressure) or pressure (positive pressure) to move the drainage fluid out of the tray, such as a pump (internal/external pump embodiments).

In embodiments, the drainage device further comprises a mechanical device configured to generate pressure to move the drainage fluid out of said tray. Exemplarily, the mechanical device is a pump, such as a mini submersible liquid water pump 150 operationally coupled to the outlet port and configured to pump drainage fluid out of the drainage device. In embodiments, the pump is positioned inside the device (connected to the inside opening of the outlet port, see FIG. 1D) or outside the device (connected to the inside opening of the outlet port, see FIG. 1C).

One example of a mini submersible pump is a Machifit JT80SL DC 3-6V Water Pump 120L/H Ultra-quiet Micro Horizontal Submersible Mini Water Pump. The pump may be powered by a battery cell or a solar panel (not shown). Alternatively, the pump can be couple to a power source, such as power mains. In some embodiments, the drainage device further includes a fan (not shown) for introducing fresh air into the device. A fan can help the flow of drainage fluid out of the tray as well as preventing stagnation of the water.

FIG. 1C shows one exemplary embodiment where a pump 150 positioned outside device 10 and coupled to the outlet port 104. The pump draws fluid out of the outlet port via an intake opening 152 connected to an intake tube 154 and propels the fluid out of an output opening 156 via an output tube 158 which is either a drainage tube itself or coupled to a drainage tube 160. Wire 162 connects the pump to a power source.

In FIG. 1D, the pump is visible inside the device 10. According to this configuration, the pump sucks the drainage fluid in via the intake opening 152 and expels the fluid out the output opening 156 which is connected to the outlet port 104 via tube 158. The outlet port 104 is coupled to a drainage tube 160.

As mentioned above, in various embodiments, the drainage device 10 has one or more outlet ports 104. A user can select the height of fluid in the tray by opening one of the outlet ports (and leaving the other sealed) or by connecting the pump 150 to an otherwise sealed port. If the pump is disposed inside the device then the output tube 158 is connected to the outlet port. If the pump is disposed outside the device then the intake tube 154 is connected to the outlet port and the drainage fluid is suctioned out of the tray under negative pressure for the pump and then propelled out of the output opening 156.

For all of the aforementioned embodiments, a drainage tube 160 is connected to the outlet fluid port, either directly or indirectly, and is adapted to provide a conduit for conveying the drainage fluid out of the tray. Three drainage options are discussed hereafter. Each of the drainage options can be applied equally to any of the aforementioned configurations (gravity, internal pump and external pump embodiments).

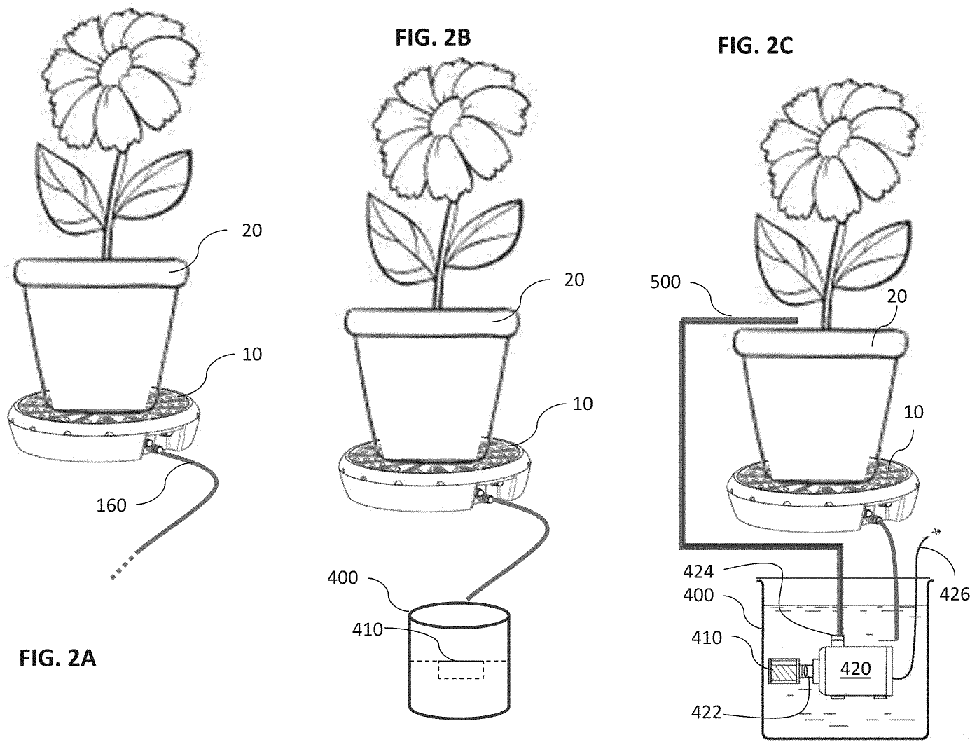

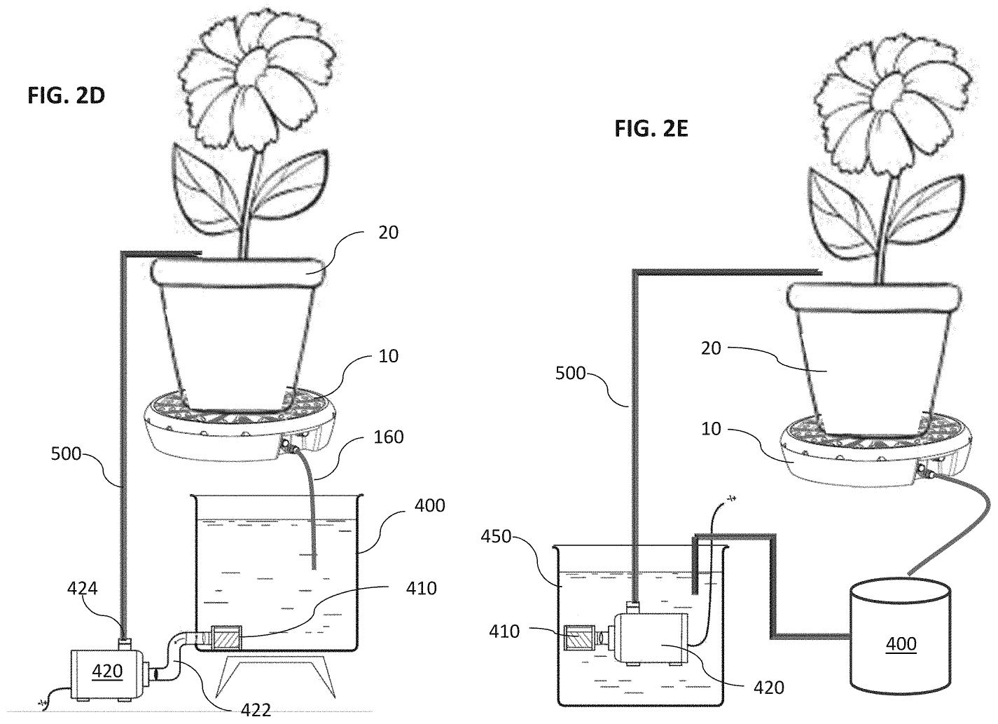

FIGS. 2A to 2E illustrate various embodiments of the drainage device arranged with a plant pot for drainage only or drainage and irrigation. FIGS. 2A and 2B depict drainage arrangements. FIGS. 2C, 2D and 2E depict drainage and irrigation arrangements. According to a first alternative, depicted in FIG. 2A, the drainage tube 160 can terminate at a disposal point, such as a sink, an outdoor garden, a drain, etc. According to second alternative embodiment, depicted in FIG. 2B, the drainage tube is coupled to a reservoir 400. The reservoir may simply be a container that is manually emptied at periodic intervals. According to a third alternative, depicted in FIGS. 2B, 2C, 2D, 2E, the reservoir 400 collects the fluid for filtering and reuse.

Three embodiments for reuse of the filtered water are disclosed hereafter, including various variations of the embodiments. In one embodiment, the reservoir includes a filter device or arrangement 410 that filters the drainage fluid. Reservoir 400 is adapted to receive the drainage fluid and filter the drainage fluid to receive filtered fluid. A filter 410 is depicted in FIG. 2B in broken lines as this is an optional variation of the embodiment with a reservoir. The filtered fluid may be reused for purposes unrelated to the drainage device.

In alternative embodiments, e.g. depicted in FIGS. 2C, 2D and 2E, the drainage fluid is filtered by a filter 410 and the filtered water/fluid is recycled back into the plant pot 20 which is located on top of the drainage device 10. To this end, e.g. as depicted in FIG. 2C, the device/system/arrangement further includes a pump 420 or some other mechanical device configured to convey (under pressure) the filtered fluid from the reservoir to the plant pot, through an irrigation tube 500.

Pump 420 has an intake opening 422 (with or without a tube) and an outlet opening 424. The pump is electrically coupled to a power source (mains, battery, power cell etc.) via a cord 426. The pump sucks fluid in through the intake opening (either directly or via an intake tube also referenced 422) and expels the fluid, under pressure, out of the outlet opening.

In embodiments, the pump is disposed/located inside the reservoir and adapted to expel the filtered fluid from the reservoir and propel/convey the fluid to the plant pot. In addition, a requisite power source and/or other machinery or components necessary for successful irrigation, as know in the art. Exemplarily, the pump is a mini submersible pump disclosed above, or any similar pump.

Irrigation tubing 500—as known in the art—is installed between the reservoir 400 and the plant pot 20. The recycled fluid is conveyed back to the plant pot through the irrigation tubing. According to a variation, the reservoir 400 further includes elements such as computer components that can be programmed (locally, via a control panel on the receptacle or remotely, e.g. via wired or wireless communication from a remotely situated control panel) to regulate the irrigation of the plant pot according to a desired schedule and amount of fluid provided at each irrigation event. According to variations, the reservoir is coupled to a water source (not shown) for supplementing the recycled fluid with fresh water where necessary (e.g. if fluid in the container falls below a predefined level, water is drawn from the water source, such as in a manner similar to the arrangement by which a toilet tank is refilled after flushing).

According to yet another variation, depicted in FIG. 2D, pump 420 is located outside reservoir 400. In such a variation, the intake tube 422 is coupled to the reservoir and the output opening 424 is coupled to the irrigation tubing 500. More than one of the aforementioned variations may be included in a single embodiment.

In another embodiment, depicted in FIG. 2E, device 10 has a plant pot 20 disposed thereon. The drainage device is in fluid communication with a reservoir 400 via a drainage tube 160. The reservoir 400 is in fluid communication with a secondary reservoir 450. Fluid is received in reservoir 400 and conveyed to secondary reservoir/container/receptacle 450 via tubing. The arrangement further includes a pump 420 operationally coupled to the secondary reservoir. The pump is adapted to move the filtered fluid to the plant pot through an irrigation tube that is in fluid communication with the pump and the plant pot. The arrangement further includes a requisite power source for the pump and/or other machinery or components necessary for successful irrigation, as know in the art.

Variations include the fluid being filtered either in the reservoir or in the secondary reservoir. Further variations include pump 420 being located either inside or outside the secondary reservoir 450. According to variations, the second receptacle includes elements such as computer components that can be programmed (locally, via a control panel on the receptacle or remotely, e.g. via wired or wireless communication from a remotely situated control panel) to regulate the irrigation of the plant pot according to a desired schedule and amount of fluid provided at each irrigation event. According to further variations, the second container 450 may be coupled to water source (not shown) for supplementing the recycled fluid with fresh water where necessary (e.g. if fluid in the container falls below a predefined level, water is drawn from the water source, such as in a manner similar to a toilet tank). More than one of the aforementioned variations may be included in a single embodiment.

In further embodiments, drainage device 10 is operationally coupled to, or in fluid communication an additional drainage device 10. In embodiments, the drainage tube 160 is operationally coupled to an inlet port of the additional drainage device 10. Various configurations are discussed below.

### Drainage System and Drainage-Irrigation System

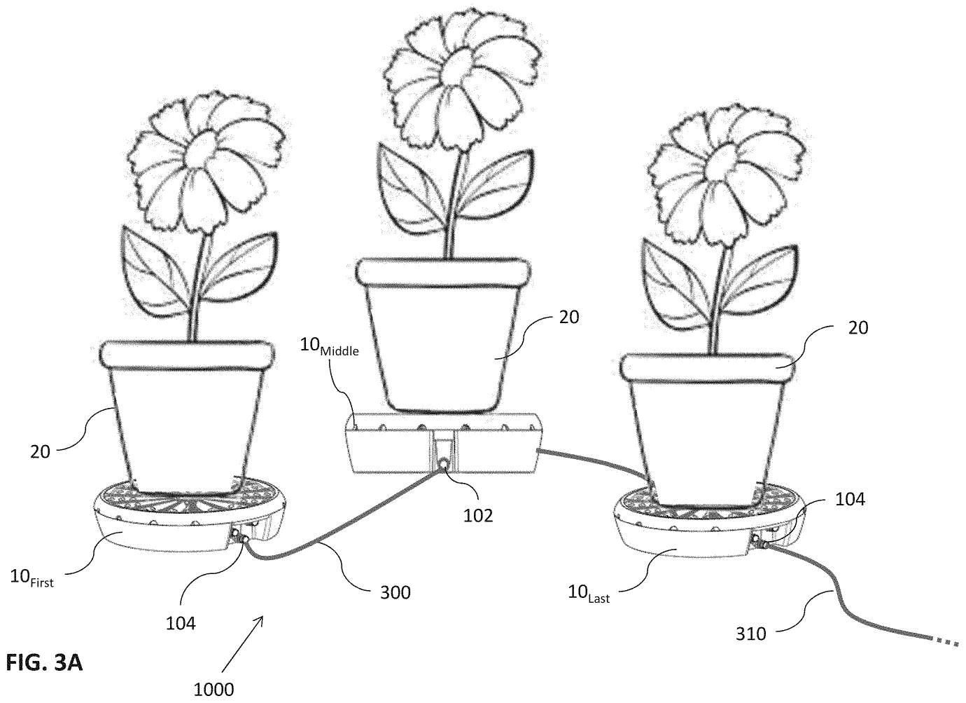

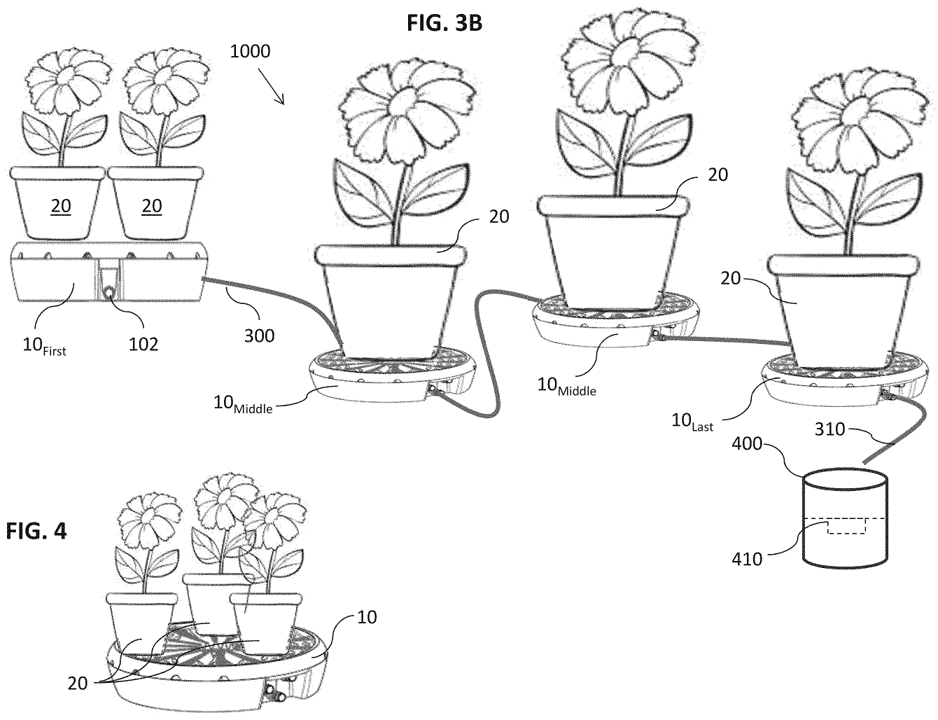

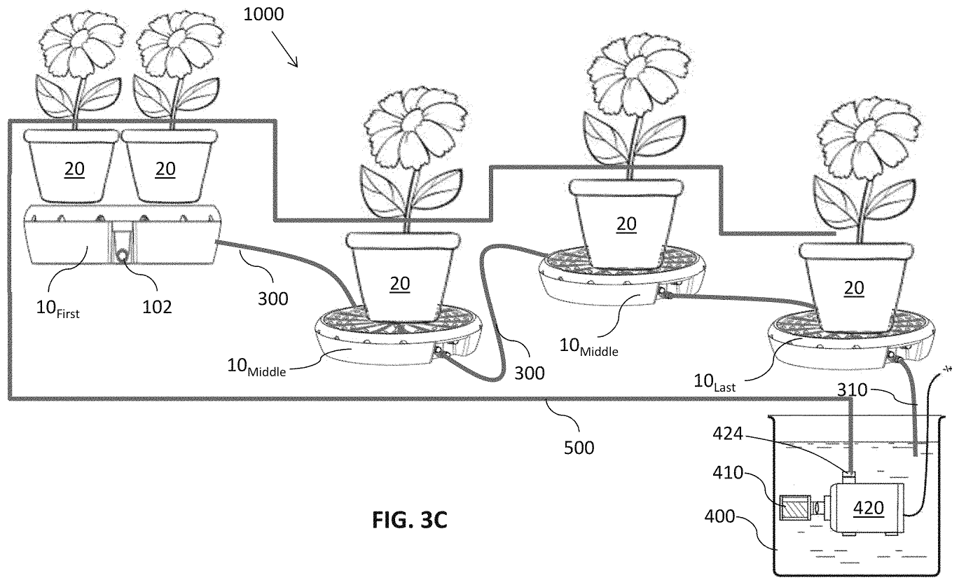

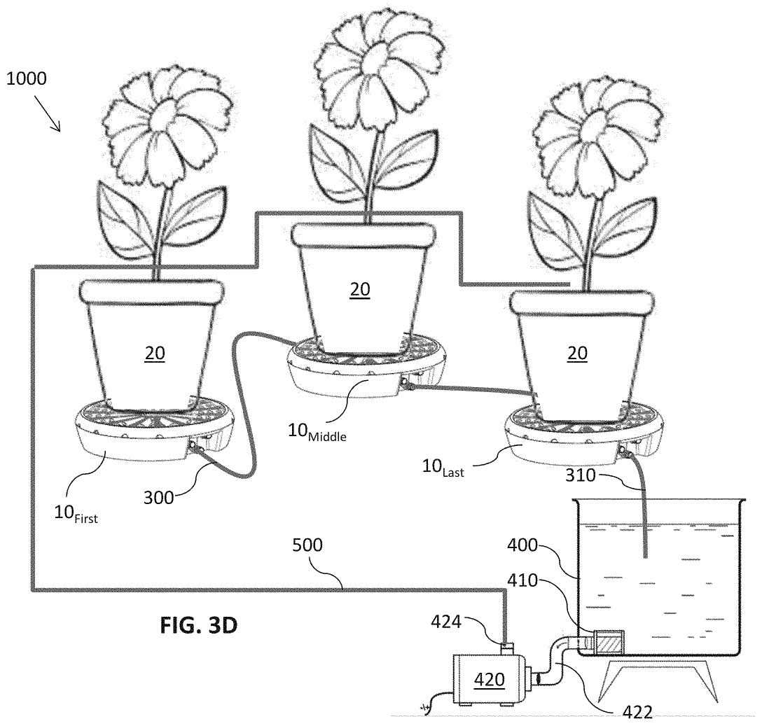

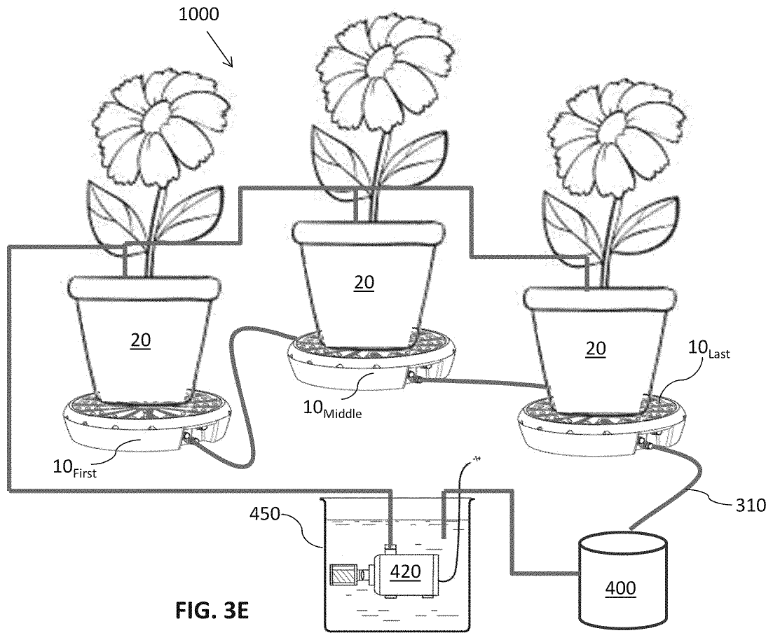

Another possible configuration is shown in FIGS. 3A to 3E which illustrate various embodiments of a drainage system employing the aforementioned drainage devices. The term “drainage system” includes drainage systems which are also irrigation systems. Therefore, where the system includes an irrigation component (see e.g. FIGS. 3C-3E), the terms “drainage system” and “drainage-irrigation system” are used interchangeably. With the drainage systems detailed hereafter, the same reference numbers are used for the same or similar elements of the drainage device and arrangements as above.

In all of the embodiments detailed hereafter, the basic drainage system 1000 includes a plurality of drainage devices 10 arranged in a sequence. The sequence includes at least a first drainage device 10_{First} and a last drainage device 10_{Last}. In embodiments there is at least one intervening drainage device 10_{Middle} or more. Each drainage device 10 is coupled to the subsequent drainage device by a tube 300. A drainage tube 310 is coupled to the final drainage device 10_{Last}.

Each drainage device 10 in the system 1000 includes a tray 100 with an inlet port 102 disposed in a sidewall 106 of the tray 100 and an outlet port 104 also disposed in the sidewall, but opposite inlet port. The device further includes a permeable cover 200 fixed on top of the tray. The cover is permeable and adapted for a base of the plant pot 20 to stand thereon or there-over, and further adapted for the drainage fluid from the plant pot to pass there-through to the tray. The drainage devices 10 are substantially similar to the drainage device 10 described above and all the specifications, optional modifications, alternative embodiments etc. apply equally to the drainage devices discussed hereafter, as if fully set forth herein.

The system further includes a plurality of tubes 300 coupling each drainage device 10 with a subsequent drainage device 10 in the sequence. The tubes are adapted to serve as conduits for drainage fluid to flow from each drainage device to the subsequent drainage device, until the last device.

The term “tube”, as used herein, is intended to widely include the terms channel, duct, line, pipe, hose, trough and the like. While the term “tube” is used herein, where relevant by context or embodiment, the term is intended to convey the characteristics usually associated with a more appropriate term, such as one selected from the aforementioned set.

The tubes are adapted to serve as conduits for drainage fluid to flow from each drainage device to the subsequent drainage device. The tubes are connected between the outlet port of one drainage device and the inlet port of the subsequent drainage device. At least the inlet port 102 (of each device) has a one-way valve to ensure that fluid enters the tray of the drainage device through the inlet port but does not flow back out thereof. In embodiments, each outlet port 104 also has a one-way valve, so that the fluid runs out of the tray but does not run back into the tray. The one-way valve or valves ensure(s) a unidirectional flow of the drainage fluid in the first-to-last device direction of the sequence. The devices may utilize gravity in draining of the fluid from tray to tray of the devices. Alternatively, mechanical methods of compelling the fluid to flow may be used, e.g. a pump.

A drainage tube 310 is connected to the outlet port of the last device 10_{Last} in the sequence. The drainage tube is adapted to provide a conduit for conveying the drainage fluid out of the last device in the sequence.

A number of variations and embodiments of the drainage system 1000 are detailed below. Each embodiment includes the basic drainage system and additional components that make up each embodiment or variation. It is made clear that the embodiments disclosed hereafter are merely exemplary and variations and modifications of the systems are intended to be included within the scope of the innovative system.

In embodiments, the drainage device 10 further comprises a mini submersible liquid water pump operationally coupled to the outlet port and configured to pump drainage fluid out of the drainage device. One example of a mini submersible pump is a Machifit JT80SL DC 3-6V Water Pump 120L/H Ultra-quiet Micro Horizontal Submersible Mini Water Pump. The pump may be powered by a battery cell or a solar panel. Alternatively, all of the pumps are coupled to a single power source, such a powerful battery or power mains.

As mentioned above, in various embodiments, the drainage device has one or more outlet ports. A user can select the height of fluid in the tray by opening one of the outlet ports or by connecting the pump outlet to an otherwise sealed port.

Preferably, a drainage tube 310 is coupled to the outlet port of the last device 10_{Last} in the series. The drainage tube 310 is connected to the outlet fluid port 104 of the last device and is adapted to provide a conduit for conveying the drainage fluid out of the tray.

In embodiments, such as the exemplary embodiment depicted in FIG. 3A, the drainage tube can terminate at a disposal point, such as a sink, an outdoor garden, a drain, etc. In alternative embodiments, such as exemplarily depicted in FIG. 3B, the drainage tube is coupled to, and terminates at, a reservoir 400. The reservoir may simply be a container that is manually emptied at periodic intervals. Alternatively the reservoir collects the fluid for filtering and reuse. In one embodiment, the reservoir includes a filter device or filter arrangement 410 that filters the drainage fluid. Filter 410 is depicted in FIG. 3B in broken lines as this is an optional variation of the embodiment with a reservoir.

The filtered fluid may be reused for purposes unrelated to the drainage device. Alternatively, as exemplarily depicted in FIGS. 3C, 3D and 3E, the filtered water may be recycled back into the plant pots 20 which are located on top of the drainage devices 10. In embodiments, each of the plurality of plant pots 20 is located on top of a respective drainage device 10 of the plurality of drainage devices in the system. In other embodiments, at least two plant pots 20 of the plurality of plant pots are located on top of at least one drainage device 10 of the plurality of drainage devices in the system.

A mechanical device configured to generate pressure is used to move the filtered fluid to irrigate the plurality of plant pots. For example, the system further includes a pump 420 (and requisite power source and/or other machinery or components necessary for successful irrigation, as know in the art) or some other apparatus for taking the filtered fluid from the reservoir and propelling/conveying the fluid to the plant pot. The mechanical device can be located inside the reservoir or outside the reservoir. Exemplarily, the same type of mini submersible pump mentioned above may be used here. The pump is operationally coupled to, or in fluid communication with, reservoir 400.

As detailed above, pump 420 has an intake opening 422 (with or without a tube), and an outlet opening 424. The pump is electrically coupled to a power source (mains, battery, power cell etc.) via a cord 426. The pump sucks fluid (under negative pressure) in through the intake opening (either directly or via an intake tube also referenced 422) and expels the fluid, under pressure, out of the outlet opening.

Irrigation tubing 500—as known in the art—is fixed between the reservoir 400 and the plant pots 20. The recycled fluid is conveyed through the irrigation tubing back to the plant pots.

In embodiments, such as the exemplary embodiment depicted in FIG. 3C, the pump 420 is disposed inside reservoir 400. A filter 410 filters the drainage fluid which is then propelled through the irrigation tubing 500 via the output opening 424.

In embodiments, such as the exemplary embodiment depicted in FIG. 3D, the pump 420 is disposed outside reservoir 400. Filter 410 filters the drainage fluid and filtered fluid is sucked out of reservoir 400, through intake tube 422, under negative pressure from the pump. The filtered fluid is propelled through the irrigation tubing 500 via the output opening 424 under positive pressure from the pump.

In other embodiments, such as the embodiment depicted in FIG. 3E, the system includes a plurality of devices and a plurality of plant pots. The last device drains into a reservoir 400. Fluid (drainage or filtered) is conveyed to a secondary reservoir/container/receptacle 450. The secondary reservoir 450 is adapted to receive drainage fluid or filtered fluid from the reservoir 400. The secondary reservoir is in fluid communication with a pump 420 which is adapted for propelling the filtered fluid to a plurality of plant pots. In embodiments, the second receptacle further includes elements such as computer components that can be programmed (locally, via a control panel on the receptacle or remotely, e.g. via wired or wireless communication from a remotely situated control panel) to regulate the irrigation of the plant pots 20 according to a desired schedule and amount of fluid provided at each irrigation event. The secondary reservoir 450 may be coupled to a water source for supplementing the recycled fluid with fresh water where necessary.

FIG. 4 depicts a single drainage device 10 according to the instant innovation, with a number of plant pots 20 are disposed on the device.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A drainage device for a plant pot, comprising:
(a) a tray adapted to receive drainage fluid from the plant pot;
(b) a cover for said drainage tray, said cover being permeable and adapted for a base of the plant pot to stand thereon, further adapted for said drainage fluid from the plant pot to pass there-through, into said tray;
(c) an outlet port disposed in a sidewall of said tray; and
(d) a drainage tube connected to said outlet port, said drainage tube adapted to provide a conduit for conveying said drainage fluid out of said tray.

2. The drainage device of claim 1, wherein said drainage tube is coupled to a reservoir that is adapted to receive said drainage fluid and filter said drainage fluid to receive filtered fluid.

3. The drainage device of claim 2, wherein said filtered fluid is recycled back into the plant pot.

4. The drainage device of claim 3, further including a pump adapted to convey said filtered fluid from said reservoir to the plant pot, through an irrigation tube.

5. The drainage device of claim 4, wherein said pump is located inside said reservoir.

6. The drainage device of claim 4, wherein said pump is located outside said reservoir.

7. The drainage device of claim 1, wherein said drainage tube is in fluid communication with a reservoir.

8. The drainage device of claim 7, wherein said reservoir is in fluid communication with a secondary reservoir that is adapted to receive said drainage fluid and filter said drainage fluid to receive filtered fluid; and further including a pump operationally coupled to said secondary reservoir, said pump adapted to move said filtered fluid to the plant pot through an irrigation tube that is in fluid communication with said pump and the plant pot.

9. The drainage device of claim 8, wherein said pump is located inside or outside said reservoir.

10. The drainage device of claim 1, wherein said drainage tube terminates at a disposal point.

11. The drainage device of claim 1, wherein said drainage tube is operationally coupled to an inlet port of an additional drainage device of claim 1.

12. The drainage device of claim 11, further comprising:
(e) a one-way valve disposed in said inlet port.

13. The drainage device of claim 1, further comprising:
(e) a one-way valve disposed in said outlet port.

14. The drainage device of claim 1, further comprising a mechanical device configured to generate pressure to move said drainage fluid out of said tray.

15. The drainage device of claim 14, wherein said mechanical device is a pump, said pump is disposed inside said drainage device and coupled to said outlet port.

16. The drainage device of claim 14, wherein said mechanical device is a pump, said pump is disposed outside said drainage device and coupled to said outlet port.

17. A drainage system, comprising:
(a) a plurality of drainage devices arranged in a sequence, including at least a first device and a last device, each device comprising:
(i) a tray adapted to receive drainage fluid from the plant pot,
(ii) a cover for said drainage tray, said cover being permeable and adapted for a base of the plant pot to stand thereon or there-over, further adapted for said drainage fluid from the plant pot to pass there-through to said tray,
(iii) an outlet port disposed in a sidewall of said tray, and
(iv) an inlet port disposed in said sidewall of said tray, opposite said outlet port;
(b) a plurality of tubes coupling each drainage device of said plurality of devices with a subsequent said drainage device in said sequence, said tubes adapted to serve as conduits for drainage fluid to flow from each said drainage device to said subsequent drainage device, until said last device; and
(c) a drainage tube connected to said outlet port of said last device, said drainage tube adapted to provide a conduit for conveying said drainage fluid out of said last device in said sequence.

18. The drainage system of claim 17, wherein said drainage tube terminates at a disposal point.

19. The drainage system of claim 17, further comprising:
(d) a reservoir, said reservoir operationally coupled to said last device via said drainage tube and adapted to receive said drainage fluid there-from.

20. The drainage system of claim 19, wherein said reservoir is adapted to filter said drainage fluid to receive filtered fluid for reuse.

21. The drainage system of claim 20, further comprising:
(e) a mechanical device configured to generate pressure to move said filtered fluid to a plurality of plant pots.

22. The drainage system of claim 21, wherein each of said plurality of plant pots is located on top of a respective said drainage device of said plurality of drainage devices.

23. The drainage system of claim 21, wherein at least two plant pots of said plurality of plant pots are located on top of at least one said drainage device of said plurality of drainage devices.

24. The drainage system of claim 21, wherein said mechanical device is disposed inside said reservoir.

25. The drainage system of claim 21, wherein said mechanical device is disposed outside said reservoir.

26. The drainage system of claim 19, further comprising:
(e) a secondary reservoir adapted to receive drainage fluid or filtered fluid from said reservoir, said secondary reservoir in fluid communication with a pump adapted for propelling said filtered fluid to a plurality of plant pots.

27. The drainage system of claim 17, wherein each said drainage device further comprises:
(v) a one-way valve disposed in said inlet port.

28. The drainage system of claim 17, wherein each said drainage device further comprises:
(v) a one-way valve disposed in said outlet port.

29. The drainage system of claim 17, wherein each said drainage device further comprises:
(v) a mini submersible liquid water pump operationally coupled to said outlet port and configured to pump said drainage fluid out of said drainage device.
